(19) United States
(12) Patent Application Publication
(10) Pub. No.: US 2026/0276493 A1
(43) Pub. Date: Sep. 17, 2026

(54) MICROPARTICLE SAMPLING AND CHEMICAL TREATMENT

(71) Applicant: Hong Kong Applied Science and Technology Research Institute Co., Ltd., Shatin (HK)

(72) Inventors: Ming Leung Vincent Tse, Tuen Mun (HK); Kwan Ho Ngai, Tseung Kwan O (HK)

(21) Appl. No.: 19/080,573

(22) Filed: Mar. 14, 2025

(51) Int. Cl. G01N 1/34; B01L 3/00

(52) U.S. Cl. CPC G01N 1/34; B01L 3/502753; B01L 2200/16; B01L 2300/0681; B01L 2300/087; B01L 2400/0457

(57) ABSTRACT

Systems and methods in which microparticles, including microparticles of plastic, are sampled and provided with a chemical treatment are described. A device for microparticle sample collection and chemical treatment may include a microparticle sample collection chamber including a first filter bed enclosed in the microparticle sample collection chamber and a first microparticle filter, a microparticle chemical treatment chamber including a second filter bed enclosed in the microparticle chemical treatment chamber and a second microparticle filter disposed within the second filter bed configured to receive the microparticles at a surface of the second microparticle filter for a chemical treatment of the microparticles; and a microparticle outflow transport system configured to transport the microparticles from the third outlet from the microparticle chemical treatment chamber without removal of the microparticles from the device. Methods of operation, including techniques for microparticle filtering, treatment, and transportation are also disclosed.

### TECHNICAL FIELD

The present invention relates generally to sample analysis systems and, more particularly, to devices and systems for microparticle sampling and chemical treatment.

### BACKGROUND OF THE INVENTION

Plastic pollution is an increasing threat to the environment, causing harm to humans, plants, and animals. Plastics are incredibly difficult to break down and may remain to pollute the environment for decades or centuries longer than organic waste products. Plastic pollution may also interfere with or contaminate manufacturing or resource collection processes. One area of concern from plastic pollution is the increasing presence of microplastics in water supplies. Microplastics, or microscopic particles of plastic (also referred to as microparticles) are difficult to collect and analyze effectively, especially as their size decreases into the range of tens of micrometers to hundreds of nanometers or smaller.

One difficulty arising in microparticle sample collection and analysis relates to the generally small concentrations of microparticles present in water environments. In order to collect a sample of microparticles large enough for a substantive analysis (e.g., a few parts per liter), large amounts of water (e.g., upwards of 500 L) must be collected or processed. Samples of large volumes of water can either be collected on-site or off-site, but transporting and storing large volumes of water to an off-site processing facility can be costly. Existing solutions for on-site sample collection on the other hand either lack sufficient power to process large volumes of water in a timely manner or are too large and cumbersome to be effectively portable to the on-site location for sample collection.

Another difficulty of microparticle sample collection and analysis is in preventing the contamination of a sample (e.g., a water sample) from microplastics or other material originating external to the sample. Contaminants to a sample may include microplastics, organic material, or other particles introduced into the sample from the air or from components of a sampling device. Moving samples from a sampling environment to an analysis environment (e.g., a laboratory) or within separate stages of an analysis environment, whether for chemical treatment or analysis, can also introduce contaminants to the samples. Contamination is a significant problem for some existing microparticle filtering and collection systems, which use open-air sieve stacks to filter microparticles by size. Additionally, some such filtering and collection systems are heavy and cumbersome to transport. Contamination may also occur during existing methods of storage and transportation of microparticle samples. For example, manually removing a microparticle sample from a filter and transporting the microparticle sample to an analysis environment can introduce contamination to the sample. Therefore, existing microparticle sampling and solutions are not sufficiently portable, powerful, or capable of isolating microparticle samples from contaminants to effectively collect, chemically treat, and analyze microparticles.

### BRIEF SUMMARY OF THE INVENTION

The present invention is directed to systems and methods for microparticle sample collection and chemical treatment. A microparticle sample collection and chemical treatment device according to embodiments may include one or more chambers isolated from an external environment, configured to isolate microparticles from a sample, and configured to provide a chemical treatment to the microparticles. The microparticle sample collection and chemical treatment device may be made small enough to be portable to an on-site location for sample collection, while remaining powerful enough to collect samples efficiently. The microparticle sample collection and chemical treatment device may be made enclosed or separated from an external environment for both collection and chemical treatment of the microparticles, which may increase accuracy in measuring microparticles and reduce contamination of microparticle samples.

To collect a sufficiently large sample of microparticles, a microparticle sample collection and chemical treatment device may include one or more mechanisms for introducing an aqueous sample from a source of the aqueous sample into a chamber where the particles can be isolated (e.g., filtered) from the aqueous sample. For example, a device may include one or more fluid pumps configured to bring an aqueous sample into a microparticle sample collection chamber to be filtered. By pumping an aqueous sample into the chamber and through a microparticle filter, microparticles can be isolated from the aqueous sample at the microparticle filter. Fluid pumps may be configured to be small enough to be portable but may still be powerful enough to pump fluid through the microparticle filter efficiently, for example, by maintaining a relatively rapid flow rate through the microparticle filter.

As a further example, a first fluid pump may be connected to the fluid inlet of the microparticle sample collection chamber, and a second fluid pump may be provided at the first outlet of the microparticle sample collection chamber. The fluid pumps may be configured to operate simultaneously, where the first fluid pump is configured to push aqueous components of the aqueous sample through the at least one microparticle filter and the second pump is configured to pull the aqueous components of the aqueous sample through the at least one microparticle filter. In some implementations, the first and second pumps may be configured to pump aqueous components of the aqueous sample through the at least one microparticle filter in a forward direction or in a reverse direction.

A microparticle sample collection and chemical treatment device may include a microparticle sample collection chamber. Such a chamber may be configured to be enclosed from an external environment. In some implementations, a microparticle sample collection chamber may include one or more enclosing members, a filter bed, and at least one microparticle filter. The filter bed may be configured to receive the at least one microparticle filter. For example, the microparticle filter, the filter bed, and other components of the microparticle sample collection chamber may be configured to nest together, that thereby the chamber may be made compact and portable. The microparticle sample collection chamber may include a first inlet through which an aqueous sample (e.g., a fluid, such as water) containing microparticles is introduced into the microparticle sample collection chamber. The at least one microparticle filter may be configured to isolate microparticles from the aqueous sample, for example, at a surface of the at least one microparticle filter or within one or more layers of the microparticle filter.

The microparticle sample collection chamber may include a first outlet through which aqueous components of the aqueous sample can be drained after the microparticles have been isolated from the aqueous sample. The microparticle sample collection chamber may further include a second outlet configured to receive the microparticles after they have been isolated and transport them to another chamber. For example, the second outlet may be configured at an angle to a plane of the surface of the at least one microparticle filter to encourage migration of the microparticles from the surface of the first microparticle filter to an output of the second outlet. In some implementations, the second outlet may be configured at an angle between substantially parallel to the plane of the surface of the microparticle filter and substantially perpendicular to the plane of the surface of the microparticle filter. An angled outlet may be useful in facilitating migration of microparticles because it may cause microparticles to slide toward the output of the angled outlet, for example, under the influence of gravity.

The microparticle sample collection chamber may also include components and mechanisms configured to facilitate migration of the microparticles to the output of the second outlet, such as an opening in the first microparticle filter corresponding to the second outlet, a vibration mechanism, a reservoir, a rinsing fluid inlet, one or more nozzles, a chamber rotation mechanism, or a combination thereof. Microparticles may become lodged in the microparticle filter or may experience chemical bonds or electrostatic forces to each other or to components of the device that make them difficult to move, and components or mechanisms to aid in their removal can be advantageous in overcoming such bonds or forces. Mechanisms to facilitate migration of microparticles may also increase the throughput of microparticle sample collection and chemical treatment processes, increasing the speed at which samples can be processed and analyzed and at the same time providing more accurate and useful results than prior systems and devices.

After pumping an aqueous sample through the microparticle sample collection chamber to isolate the microparticles, a chemical treatment may be applied to the microparticles inside the chamber. The chemical treatment may prepare the microparticles for later detection or analysis, such as by adding a dye to the microparticles or by causing a chemical reaction with the microparticles. The chemical treatment may be provided in the same chamber as the filter that isolated the microparticles from the aqueous sample, or the microparticles may be transported to another chamber for chemical treatment.

To prevent contamination, the microparticles may be transported to another chamber in an automated manner. For example, the microparticles may be transported through a channel from the first chamber to the second chamber without removing the microparticles from the enclosed environment of the microparticle sample collection and chemical treatment device. Beyond preventing contamination, automated transport mechanisms allow for functionality without requiring direct human interaction or external manipulation.

According to embodiments, the microparticle sample collection and chemical treatment device may include a microparticle chemical treatment chamber. The microparticle chemical treatment chamber may be connected to the second outlet of the microparticle sample collection chamber and configured to receive microparticles from the microparticle sample collection chamber. The microparticle sample collection chamber may include a second microparticle filter. The second microparticle filter may be disposed in a second filter bed in the microparticle chemical treatment chamber. The second microparticle filter may be made of a chemically inert material so that it is not affected by chemical treatments applied to the microparticles.

The chemical treatments applied to the microparticles may include applying a dye to the microparticles; applying ethanol, isopropyl alcohol, or another alcohol to the microparticles; applying acetone or another solvent to the microparticles; applying water (e.g., distilled water or deionized water) to the microparticles; applying an alkali or an acid to the microparticles; removing, dissolving, or otherwise changing particles not of interest (e.g., organic particles, or particles which are not microplastics), applying heat to the microparticles, applying an abrasive material to the microparticles, applying a binding agent to the microparticles, causing a Fenton reaction with the microparticles, or a combination thereof.

Like transportation of the microparticles into, within, or out of the system, application of a chemical treatment to the microparticles may be performed in an automated manner, or without manual application or transfer of the microparticles, which has the advantage of preventing contamination that could be introduced under manual chemical application. Automated systems may also be more precise in their application of chemicals than a human's manual application of chemicals.

The microparticle chemical treatment chamber may include a heating element, which may facilitate a chemical treatment of the microparticles. The heating element, the filter bed, the second microparticle filter, a reservoir, and/or other components of the microparticle chemical treatment chamber may be configured to nest within one another and/or an enclosing member of the microparticle chemical treatment chamber. An advantage of such a configuration is that it creates a more compact and thus more portable chamber, useful for field applications.

In some implementations, the microparticle chemical treatment chamber may include a chemical waste container. In some implementations, positive or negative air pressure may be applied to the microparticles on the second microparticle filter and/or to one or more components of the microparticle chemical treatment chamber, such as the chemical waste container. Application of positive or negative air pressure may facilitate application of a chemical treatment to the microparticles. For example, applying air pressure may encourage rapid transfer of chemicals from the second microparticle filter to the microparticles or to the chemical waste container.

The microparticle sample collection and chemical treatment device may include one or more microparticle outflow transport systems. Microparticle outflow transport systems may include features and/or mechanisms designed to encourage or facilitate the transport of microparticles from either or both of the microparticle sample collection chamber and the microparticle chemical treatment chamber. While microparticles may naturally migrate down a slope, e.g., of an angled outlet, their migration may be sped along by one or more microparticle outflow transport systems. For example, microparticles may become lodged in the microparticle filter of either the microparticle sample collection chamber or the microparticle chemical treatment chamber, and may not easily move or outflow without additional encouragement.

Exemplary systems to facilitate microparticle outflow may include mechanisms for rotating or tilting the microparticle filter (e.g., a motor) so that an outlet for the microparticles is lower than the microparticle filter, thereby aiding downward flow of microparticles to the outlet; mechanisms for vibrating the microparticle filter (e.g., an ultrasonic vibration source), thereby shaking the microparticles loose from the filter; and/or mechanisms or features to provide a chemical rinse in which the microparticles may be suspended. A chemical rinse may both help to dislodge microparticles from the microparticle filter and facilitate migration of the microparticles from the chamber, as microparticles may be more easily transported while carried or suspended within a fluid. For example, a fluid in which a microparticle sample is suspended may be easier to transport through a system than the microparticles on their own, without a fluid. The microparticle outflow transport system(s) may include one or more pumps connected to the outlets of the chamber configured to facilitate migration of the microparticles from the chamber (e.g., by pumping the fluid carrying the microparticles).

Advantages of devices according to embodiments of the invention include that the microparticles can be isolated from an environment in which they were sampled and provided with a chemical treatment without introducing contaminants to the sampled microparticles. Additionally, the device may be made portable by reducing the space that the several components of the device take up. For example, the chambers of the device may be made smaller and thus more portable by configuring components of the chambers to nest within each other. A device configured according to concepts of the invention may be made rugged and robust enough for field operation, with components precise enough to collect and apply chemical treatment to microparticles, thus facilitating more accurate and timely sample collection and analysis.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a device for microparticle sampling and chemical treatment, including a microparticle sample collection chamber, a microparticle chemical treatment chamber, and a microparticle outflow transport system according to embodiments of the present invention;

FIG. 2A shows an exploded view of an example configuration of a microparticle sample collection chamber according to embodiments of the present invention;

FIG. 2B shows a perspective view of an example configuration of a microparticle sample collection chamber according to embodiments of the present invention;

FIG. 3 shows a perspective view of an example filter bed for a microparticle sample collection chamber or a microparticle chemical treatment chamber according to embodiments of the present invention;

FIG. 4 shows an exploded cross-sectional view of an example filter bed for a microparticle sample collection chamber or a microparticle chemical treatment chamber according to embodiments of the present invention;

FIG. 5 shows a perspective view of an example configuration of a microparticle sample collection chamber according to embodiments of the present invention;

FIG. 6A shows an exploded view of an example configuration of a microparticle chemical treatment chamber according to embodiments of the present invention;

FIGS. 6B and 6C show a perspective view of a of an example configuration of a microparticle chemical treatment chamber according to embodiments of the present invention;

FIG. 7 shows a perspective view of an example configuration of a microparticle chemical treatment chamber according to embodiments of the present invention;

FIG. 8 shows a perspective view of an example microparticle outflow transport system; and

FIG. 9 shows a flowchart of an example process for performing microparticle sample collection and chemical treatment according to embodiments of the present invention.

In the figures, like reference numbers refer to like elements. It should be understood that the figures may be presented partially or diagrammatically. Some figures are presented by omitting features in order that components or operations may not be obscured. While the figures present several example components, not every component may be necessary in every embodiment. Nor does every embodiment need to be arranged exactly as in the figures in order to practice the principles disclosed herein. Alternative constructions are described herein for purposes of example only, and should not be construed as limiting the scope of this disclosure or the claims.

### DETAILED DESCRIPTION OF THE INVENTION

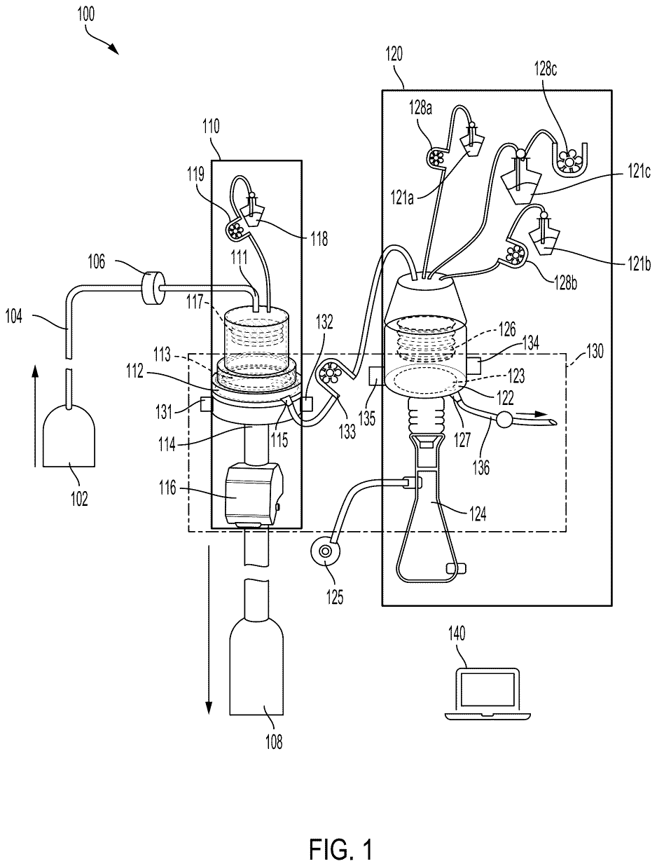

FIG. 1 shows a device for microparticle sampling and chemical treatment in accordance with concepts of the present invention. The illustrated example of microparticle sampling and chemical treatment device 100 includes a microparticle sample collection chamber, a microparticle chemical treatment chamber, and a microparticle outflow transport system according to embodiments of the present invention. As will be better understood from the description below, device 100 of embodiments provides for an enclosed series of chambers configured to filter, or isolate, microparticles from a fluid (e.g., from water) and to transport the microparticles in an automated manner between the chambers so that the microparticles can be chemically treated and analyzed without being manually removed from the chambers. The arrangement of chambers and components is made compact and portable so that the device 100 may be used for on-site sampling and chemical treatment.

In the example of FIG. 1, device 100 includes microparticle sample collection chamber 110, microparticle chemical treatment chamber 120, and microparticle output transfer system 130. Device 100 may optionally include a controller 140, configurable to control various aspects of the device, including control of various pumps, actuators, valves, and other controllable components useful in performing microparticle sampling and chemical treatment using the device 100. Device 100 may optionally include one or more features or mechanisms for introducing a sample including microparticles into the microparticle sample collection chamber 110 (e.g., one or more pumps, such as first pump 102 or second pump 108).

Device 100 may include one or more features or mechanisms for transporting the microparticles from the microparticle sample collection chamber 110 to the microparticle chemical treatment chamber 120 or from the chemical treatment chamber 120 to an output of the device. As will be described in greater detail herein, the device 100 may make use of geometries of its components either on their own or in combination with other mechanisms to facilitate the migration of microparticles from one part of the device 100 to another. For instance, the chambers of device 100 may include angled outlets through which microparticles may migrate to other components or chambers of the device 100. Other mechanisms, features, or systems may be provided to facilitate this migration, including mechanisms for rotating or tipping the chambers toward angled outlets, mechanisms for vibration of the chamber, mechanisms providing chemical rinsing of the microparticles, mechanisms providing air pressure on the microparticles, mechanisms for centrifugal motion and removal of the microparticles, and other such features. Any or all of these features may be used in combination with each other to provide an enclosed system for microparticle sampling, chemical treatment, and transport.

Device 100 may optionally include one or more structural features to facilitate portability, ruggedness, transport, or use in field applications, such as one or more handles, one or more structural support members, a frame, and/or a mounting stand. Device 100 may also optionally include chemical storage containers containing chemicals for use in the microparticle chemical treatment chamber 120, tubing or other fluid connections through which the chemicals may be provided to the microparticle chemical treatment chamber 120, and features or mechanisms for causing the chemicals to enter the microparticle chemical treatment chamber 120. Device 100 may optionally include systems or features for detecting, analyzing, storing, processing, or otherwise manipulating microparticle samples after providing a chemical treatment to the microparticles.

An advantage of device 100 is that it may isolate microparticles from an environment in which they were sampled and provide the microparticles with a chemical treatment without introducing contaminants to the sampled microparticles. In other words, device 100 operates as a microparticle sampling and chemical treatment device that maintains microparticles in an enclosed environment. Additionally, the device 100 may be made portable by reducing the space that the several components of the device 100 take up. For example, the microparticle sample collection chamber 110 or the microparticle chemical treatment chamber 120 may be made small and thus more portable by configuring components of the chambers to nest within each other, examples of which are provided herein.

According to embodiments, device 100 may include a microparticle sample collection chamber 110. Device 100 may include one or more pumps configured to introduce an aqueous sample (e.g., a fluid or a solution, such as water), which may contain microparticles, into the microparticle sample collection chamber 110. For example, device 100 may include a first pump 102, a conduit 104, a flow rate sensor 106, and a second pump 108. First pump 102 and second pump 108 may be submersible pumps. First pump 102 and second pump 108 may be configured to operate simultaneously. For example, first pump 102 may be configured to introduce the aqueous sample into the microparticle sample collection chamber 110 by pushing the aqueous sample into the microparticle sample collection chamber 110 while second pump 108 may be configured to pull aqueous components of the aqueous sample out of the microparticle sample collection chamber 110.

First pump 102 and second pump 108 may be connected to a power supply. For example, the first pump 102 and the second pump 108 may be battery operated. In some exemplary implementations, either or both of first pump 102 and second pump 108 may be configurable to operate with a power supply of a 12 V battery, a 24 V battery, or another voltage. In some implementations, a 24 V battery may include two 12 V batteries connected in series. One reason for using first pump 102 to push an aqueous sample into the microparticle sample collection chamber 110 and second pump 108 to pull the aqueous sample from the microparticle sample collection chamber 110 is that the individual pumps work together to move the aqueous sample. Because each pump individually can perform less work when operated in tandem with the other, the pumps overall may be made smaller and more portable, or may operate on smaller voltages from a portable power source (e.g., a portable battery).

Battery operated pumps (e.g., 24 V pumps) may be sufficiently powerful to move volumes of an aqueous sample into and out of the sample collection chamber in a reasonably short amount of time while being small enough to remain portable. For example, in some implementations, the pump or pumps may be configured to deliver an aqueous sample at a flow rate of 15 liters per minute. Higher or lower flow rates could also be implemented, depending on varied factors including aqueous sample viscosity, microparticle concentration, dimensions of pores in the microparticle filters, pump power, power supply charge, and so on.

Conduit 104 may be selectively configurable to connect with a first inlet 111 of the microparticle sample collection chamber 110. In some implementations, standard fluid connections may be used for interconnectivity between the various components of the device 100. For example, a fluid connection may be of size DN6, DN8, DN15, or another standard size. Alternatively, the fluid connection at the first inlet 111 may include a custom connector.

Microparticle sample collection chamber 110 may be configured to be enclosed from an external environment. In some implementations, microparticle sample collection chamber 110 may include one or more enclosing members, a first filter bed 112, and at least one microparticle filter 113. The filter bed 112 may be configured to receive the at least one microparticle filter 113. The microparticle sample collection chamber 110 may include a first inlet 111 through which an aqueous sample (e.g., a fluid, such as water) containing microparticles is introduced into the microparticle sample collection chamber. Aqueous components of the aqueous sample may pass through the at least one microparticle filter 113 (also referred to as a first microparticle filter). The at least one microparticle filter 113 may be configured to isolate microparticles from the aqueous sample, for example, at a surface of the at least one microparticle filter 113.

The microparticle sample collection chamber may include a first outlet 114 through which aqueous components of the aqueous sample can be drained after the microparticles have been isolated from the aqueous sample. The first outlet 114 may be arranged so that it is substantially perpendicular to a plane of the microparticle filter 113, which may allow for more effective filtering of microparticles. In such a configuration, the aqueous sample may be pumped into the microparticle sample collection chamber 110, through the microparticle filter 113, and out of the microparticle sample collection chamber 110 through the first outlet 114.

The microparticle sample collection chamber 110 may further include a second outlet 115 configured to receive the microparticles after they have been isolated, for example, to transport the microparticles to another chamber. The second outlet 115 may include an opening in the microparticle sample collection chamber 110 and a channel connecting the opening to the microparticle filter 113. A purpose of the second outlet 115 is to provide an outlet to the chamber connected to a side or portion of the microparticle filter 113 where the microparticles are isolated, so that the microparticles can be transported from the microparticle filter 113 for other operations, examples of which are described herein. For example, the second outlet 115 may be connected directly to a portion (e.g., a surface) of the microparticle filter 113 where the microparticles are isolated, while the first outlet 114 may be connected to a portion of the microparticle filter 113 that is not where the microparticles are isolated, such as an outlet of the microparticle filter 113. For microparticle filters that are roughly planar, such as screens and meshes, this may mean forming connections for the respective outlets to opposite sides of the microparticle filter. Planar filters are largely described herein because they can be configured more compactly than other shapes of microparticle filters, but those of ordinary skill in the art would recognize that different filter shapes may nonetheless be used in accordance with principles disclosed herein. For microparticle filters of different shapes, the configuration of first and second outlets may be different. For example, in the case of cylindrical microparticle filters, the first outlet may be connected to an outer surface of the cylindrical microparticle filter, while the second outlet may be connected to an inner surface of the microparticle filter, or vice versa, depending on how the microparticle filter is configured to interact with the fluids and/or particles. These examples are meant to provide illustration of the functionality of the outlets and not limitation, and it is anticipated that other filter and/or outlet configurations may be used without departing from the scope of this disclosure.

The second outlet 115 may be configured at an angle to a plane of the surface of the at least one microparticle filter 113 to encourage migration of the microparticles from the surface of the at least one microparticle filter 113 to an output of the second outlet 115. The angle of the second outlet relative to the surface of the at least one microparticle filter 113 may be between 10 degrees and 45 degrees, although other angles may be used. An angled second outlet 115 may provide a path by which microparticles can exit the microparticle sample collection chamber 110 after being isolated. In some cases, the angle of the second outlet 115 may also be configured to complement an angle to which the microparticle sample collection chamber may be configured to rotate, so that thereby the overall rotation of chamber, microparticle filter, and second outlet may form a steep angle (e.g., between 45 and 90 degrees from a horizontal plane) for facilitating the removal of microparticles from the sample through the second outlet.

The second outlet 115 may include a channel through which fluid and/or microparticles may pass. The second outlet 115 may be arranged so that it is in fluid communication with both the surface of the at least one microparticle filter 113 and the output of the second outlet 115. For example, the second outlet may include an opening arranged in the side of the filter bed 112 so that the opening is at least partially above the surface of the microparticle filter 113. Alternatively, the microparticle filter 113 may include an opening through which microparticles may pass to the second outlet 115. In either of these exemplary configurations, there is provided a passage from the surface of the microparticle filter 113 to second outlet 115.

In some implementations, microparticle sample collection chamber 110 may include a valve 116. Valve 116 may be disposed at an output of the microparticle filter 113, such that the valve 116 may facilitate draining of aqueous components of the aqueous sample from the microparticle sample collection chamber 110 after microparticles have been isolated by the microparticle filter 113. Valve 116 may alternatively be disposed at the first outlet 114 of the microparticle sample collection chamber 110. Valve 116 may be a shutter valve. Additionally or alternatively, valve 116 may be electronically controlled. Valve 116 may be configured to be normally open to allow for a high flow rate through the microparticle sample collection chamber 110 and fluid exiting through the first outlet 114. Valve 116 may be configured to close in response to a trigger signal from the controller 140. For example, the trigger signal to close the valve 116 could be provided by the controller 140 in response to a signal from the flow rate sensor 106. The valve 116 may be configured to remain open while the first pump 102, the second pump 108, or both, are in operation, and close after the pumps are shut off or are no longer pumping the aqueous sample.

When the valve 116 is closed, the microparticles isolated at the surface of the microparticle filter 113 may migrate from the surface of the microparticle filter 113 to the second outlet 115 of the microparticle sample collection chamber 110. As such, the valve 116 may facilitate the migration of microparticles from the chamber. For example, because the first outlet 114 is closed, the second outlet 115 may become the only outlet for fluid to leave from the microparticle sample collection chamber 110. Any fluid introduced into the microparticle sample collection chamber 110 after the valve 116 is closed would not be able to exit through the closed valve 116 or the first outlet 114, and so would have to exit the chamber through the second outlet 115. The fluid output at the second outlet 115 may be configured to transport microparticles from the microparticle sample collection chamber 110 (e.g., microparticles suspended in a fluid). While microparticles may be encouraged toward the second outlet 115 without the valve 116 based on the geometry of the chamber and/or of the second outlet 115, by closing the valve 116, the transport of microparticles may be more quickly facilitated, aiding with goals of processing microparticle samples quickly and efficiently.

In some implementations, microparticle sample collection chamber 110 may optionally include an enclosed sieve stack 117. For example, the enclosed sieve stack 117 may include a cascading set of sieves or filters configured to filter the aqueous sample for particles of various sizes, such that lower sieves in the stack have a smaller pore size than higher sieves. In some implementations, the sieves in the enclosed sieve stack 117 may have pores or openings with sizes between 1 μm and 1000 μm, although larger or smaller openings could also be used. An enclosed sieve stack 117 may allow for different sizes of microparticles to be collected and analyzed. Alternatively, or additionally, the filter bed 112 may be configured to accommodate different sizes of microparticle filter 113, such that the effect of a sieve stack could be replicated by changing the size of the microparticle filter 113 (e.g., removing a first microparticle filter and replacing it in the filter bed 112 with another microparticle filter), or by having multiple microparticle sample collection chambers in succession with each other, with different filters of different sizes.

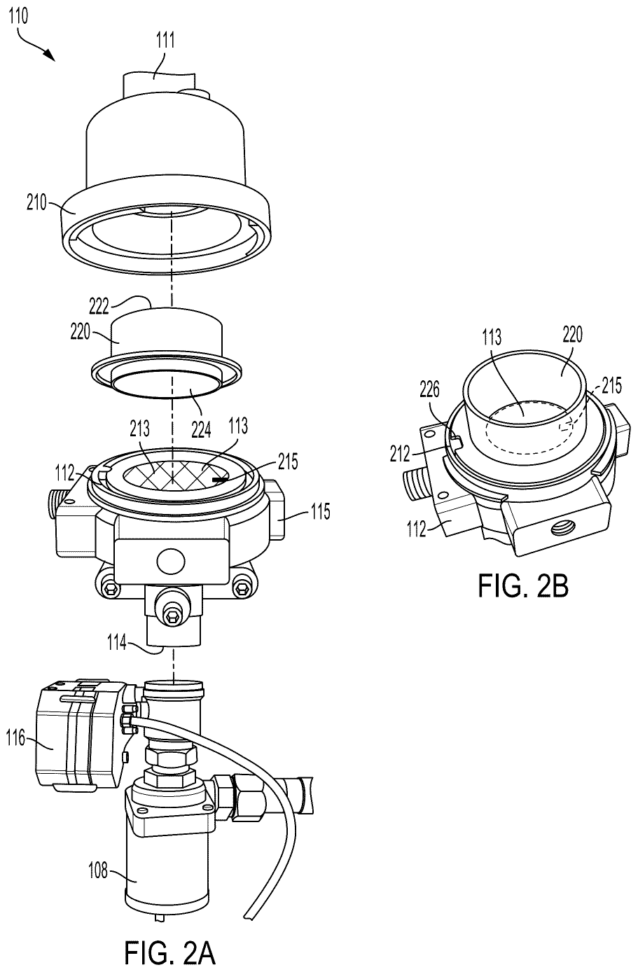

FIG. 2A shows an exploded view of an example configuration of a microparticle sample collection chamber 110 according to embodiments of the present invention. Microparticle sample collection chamber 110 of the illustrated embodiment includes an enclosing member 210, a reservoir 220, a first filter bed 112, a first microparticle filter 113, a first outlet 114, a second outlet 115, an opening 215 in the first microparticle filter 113 corresponding to the second outlet 115, and a valve 116.

In the example of FIG. 2A, components of the microparticle sample collection chamber 110 may be configured to nest within each other within the microparticle sample collection chamber 110. For example, the filter bed 112, the microparticle filter 113, the reservoir 220, and the enclosing member 210 may all be configured to nest together. This may form a compact and portable configuration of the microparticle sample collection chamber 110. The enclosing member 210 may be configured to enclose the components of the microparticle sample collection chamber 110 and thus to form the chamber itself. The enclosing member may include means for securing itself to the filter bed 112, such as one or more fasteners, a threaded connection, a grooved connection, a locking connection, one or more clamps, a friction connection, a pressure fitting, or some other suitable structure. The enclosing member 210 or the other components may be configured to include sealing members such O-rings, sealing grease, petroleum jelly, silicone, polytetrafluoroethylene (PTFE) sealant, or other kinds of sealing members. The material of a sealing member may depend on the chemicals or fluids it is designed to seal against. The enclosing member 210, when attached or secured to the filter bed 112, may form an enclosed chamber.

The first microparticle filter 113 may include a surface 213 at which microparticles may be isolated from an aqueous sample. The surface 213 of the first microparticle filter 113 may be a made of a porous material, such as a mesh, a screen, or a similar porous structure. For example, the surface 213 may include pores large enough to allow fluid (e.g., aqueous components of the aqueous sample) to pass through the microparticle filter 113 but small enough that microparticles larger than the pores cannot pass through the microparticle filter 113. Example pore sizes can include pores of between 1 μm and 1000 μm, although larger or smaller openings could also be used. In an embodiment, the pore size may be 20 μm such that microparticles having a size greater than or equal to 20 μm may be collected. The size of the pores in the microparticle filter 113 may influence the flow rate through the chamber, with smaller pores impeding the flow of the aqueous sample more than larger pores. The first microparticle filter 113 may be formed of one or more materials useful to filter microparticles from an aqueous sample. For example, the first microparticle filter 113 may be formed of stainless steel, PTFE, or fiberglass, as non-limiting examples. Embodiments using stainless steel for the first microparticle filter 113 may enable higher flow rates through the microparticle filter 113 than PTFE or other materials, though different configurations of chamber dimensions or pore diameters may compensate for this difference.

The microparticle sample collection chamber 110 may also include one or more components or mechanisms configured to encourage migration of the microparticles to the output of the second outlet 115 in combination with the angle of the second outlet 115. For example, microparticle sample collection chamber 110 of examples may include reservoir 220, a rinsing fluid supply 118, a rinsing fluid pump 119, one or more nozzles connected at a rinsing fluid inlet of the microparticle sample collection chamber 110, or a combination thereof configured to encourage migration of microparticles.

The microparticle sample collection chamber 110 may also be connected to one or more components or mechanisms of the microparticle outflow transport system 130 shown in FIG. 1, such as vibration mechanism 131, rotation mechanism 132, and transfer mechanism 133, which may facilitate the migration of the microparticles from the microparticle sample collection chamber 110 to the microparticle chemical treatment chamber 120. The components, mechanisms, and devices of the microparticle outflow transport system 130 may be configured to work in combination with the geometry of the microparticle sample collection chamber 110 to facilitate the migration of microparticles from the chamber. For example, the combined application of mechanisms within the chamber and outside the chamber may create a more effective transport of microparticles than may be achieved by any one of the mechanisms applied alone.

The reservoir 220 may be capable of receiving a volume of fluid, whether the aqueous sample, a rinsing fluid, a chemical fluid, a carrying fluid (e.g., a fluid configured to carry other particles in suspension), or some other fluid. Providing a volume of a rinsing fluid may facilitate the migration of microparticles from the microparticle filter 113 to the second outlet 115 during operations of the device 100. Operationally, after sufficient amounts of the aqueous sample have passed through the microparticle sample collection chamber 110 that a sample of microparticles is isolated at the microparticle filter 113, the aqueous sample may cease to be introduced into the microparticle sample collection chamber 110. At this point, a volume of rinsing fluid may be provided to facilitate the migration of microparticles from the microparticle sample collection chamber 110. Non limiting examples of rinsing fluid include ethanol, isopropyl alcohol, acetone, water, sheath fluid, sample liquid, and so on. If the fluid is a rinsing fluid, or a chemical fluid, it may be provided by the rinsing fluid pump 119 from a rinsing fluid supply 118. In examples, the rinsing fluid may be introduced into the microparticle sample collection chamber 110 through a nozzle configured to spray and or fan out the rinsing fluid over the microparticle filter 113. This may increase the distance that fluid may travel when introduced into the chamber, and may facilitate the migration of particles when used in combination with other particle migration mechanisms. In examples, the inlet for rinsing fluid may be configured so that the rinsing fluid may be introduced at a portion of the microparticle filter 113 opposite the opening 215. Such a configuration of an inlet or a nozzle for the rinsing fluid may facilitate transfer of microparticles from the surface 213 of the microparticle filter 113 to the opening 215. Rinsing fluid application may be especially effective when the microparticle sample collection chamber 110 is rotated to an angle where the opening 215 is lower than other portions of the microparticle filter 113. In examples, rinsing fluid may be applied multiple times to facilitate microparticle transfer. Multiple applications of rinsing fluid may increase the number of microparticles transferred.

The rinsing fluid pump 119 may be a peristaltic pump or another suitable pump configuration. In some implementations, the rinsing fluid pump 119 may be configured to pump rinsing fluid to and/or through the at least one microparticle filter 113 in a forward direction or in a reverse direction. For example, the pumps may be configured with a double pole double throw (DPDT) relay to enable direction switching. A second rinsing fluid pump may be configured to facilitate such forward or reverse pumping action. The reservoir 220 may include a first opening 222 and a second opening 224, such that the reservoir 220 may allow fluid to enter or exit a central portion of the reservoir from the first opening 222 or the second opening 224 of the reservoir 220. Switching the direction of flow for the rinsing fluid may facilitate more rapid dislodgement or migration of microparticles from the microparticle filter 113, and thus more rapid microparticle sample analysis.

The reservoir 220 may be formed of a ring structure, as shown in FIG. 2A and FIG. 2B. FIG. 2B shows a perspective view of an example configuration of a microparticle sample collection chamber 110 according to embodiments of the present invention. For example, as shown in FIG. 2B, the reservoir 220 may be disposed directly over the first microparticle filter 113 to form a volumetric space above the first microparticle filter 113. In some examples, the volume of the reservoir 220 may be 20 milliliters, although other volumes may also be possible or suitable. Thus, when assembled together with the first filter bed 112 and the first microparticle filter 113, the reservoir 220 may be capable of receiving a volume of fluid at the surface 213 of the microparticle filter 113.

The volume of fluid received at the reservoir 220 may be introduced to the reservoir after valve 116 is closed to facilitate migration of the microparticles from the surface of the first microparticle filter 113 to the second outlet 115, in combination with the angled geometry of the second outlet 115. In embodiments, fluid introduced to the reservoir 220 may facilitate transporting the microparticles toward the second outlet 115 through the opening 215. Fluid transport of microparticles may be especially effective when the fluid is introduced in combination with angled outlets and microparticle transport mechanisms as described herein.

Additionally, the reservoir 220 and the first microparticle filter 113 may fit or nest together within the first filter bed 112. In some implementations, a notch 226 in the reservoir 220 may interconnect with a tab 212 in the first filter bed 112. The purpose of such a notch 226 and tab 212 could include facilitating an alignment of the reservoir within the first filter bed 112 or to help secure the several components in place, while all nested together. While described here as a notch 226 and a tab 212, the relative positions of the notch 226 and tab 212 could be changed, with the notch 226 in the filter bed 112 and the tab 212 in the reservoir 220, or another suitable structure could be used. The openings 222 and 224 of the reservoir may align over the first outlet 114, the second outlet 115, and the opening 215 in the first microparticle filter 113 corresponding to the second outlet 115.

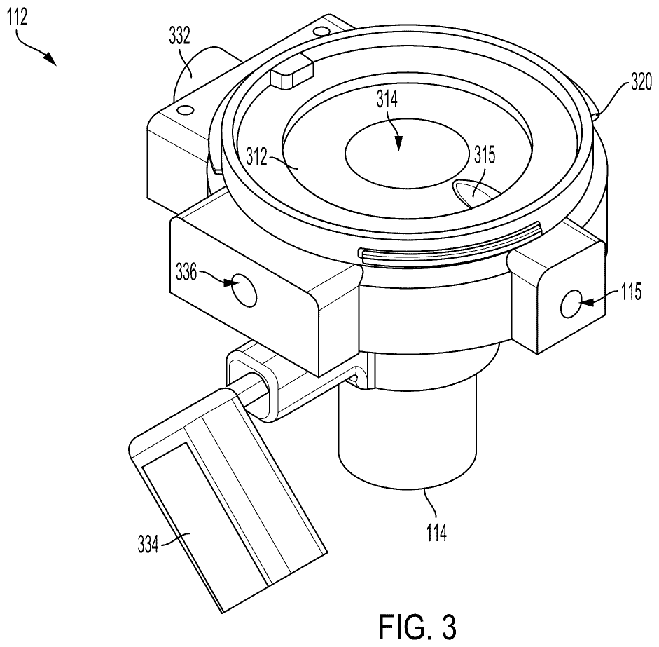

Reference is now made to FIG. 3, which shows a perspective view of an example filter bed for a microparticle sample collection chamber or a microparticle chemical treatment chamber according to embodiments of the present invention. For purposes of this description, the example filter bed of FIG. 3 is labelled as first filter bed 112 and is described with respect to the microparticle sample collection chamber 110. In some implementations the second filter bed 122 of FIG. 1 discussed in greater detail below with respect to the microparticle chemical treatment chamber 120 may have a similar structure to the first filter bed 112.

As shown in FIG. 3, filter bed 112 may include a recess 312, a first opening 314 corresponding to the first outlet 114, and a second opening 315 corresponding to the second outlet 115. The recess 312 may be configured to receive and hold a microparticle filter (e.g., first microparticle filter 113). In some implementations, an alignment feature, such as a groove, a tab, or a similar feature may be provided in the filter bed 112 or in the recess 312 that may be keyed to a corresponding feature in the microparticle filter 113 to facilitate its orientation within the recess 312. In some implementations, the second opening 315 may function as such an aligning feature.

The second opening 315 may correspond to the opening 215 in the microparticle filter 113 described above. The opening 215 in the first microparticle filter 113, in combination with the second opening 315 in the filter bed 112, may provide an angled geometry through which microparticles may be moved from the microparticle filter 113 to the second outlet 115. Other mechanisms, features, or systems may be provided to facilitate this migration, and enable movement of microparticles without human intervention or manual removal and transport. Such mechanisms may include mechanisms for rotating or tipping the chambers toward the angled second outlet 115, mechanisms for vibrating the chamber, mechanisms providing chemical rinsing of the microparticles (e.g., such as described above with reference to rinsing fluid pump 119 and reservoir 220), mechanisms providing air pressure on the microparticles, mechanisms for centrifugal motion and removal of the microparticles, and other such features. In the example of FIG. 3, the filter bed 112 may include connectors to which vibration, rotation, or other mechanisms may be attached, for example, connections 332, 334, and 336. Any or all of these features may be used in combination with each other to facilitate the movement and transport of microparticles through the device. While not every such feature may be needed in every embodiment to achieve the desired effect of facilitating and encouraging migration of the microparticles through the system, it is understood that multiple features and mechanisms working in combination with each other may have an increased effect on microparticle migration and transport through the angled channels described herein.

The first opening 314 and the second opening 315 may be formed in the recess 312 of the filter bed 112. The first opening 314 may pass completely through the filter bed 112 to the first outlet 114, such that fluid may be drained through the first opening 314 and the first outlet 114. In embodiments, the first opening 314 may be larger than the second opening 315 to facilitate draining of aqueous components of the aqueous sample through the second opening. Second opening 315 may form an angled channel through a side of the filter bed 112 to the second outlet 115. The angled channel between second opening 315 and second outlet 115 may be configured at a steeper or a shallower angle such that the second outlet 115 is located at a different location in the filter bed 112 than is shown here.

The filter bed 112 may include other components or connections. For example, the filter bed 112 may include a connection means 320 for securing the filter bed 112 to an enclosing member (e.g., enclosing member 210) of the microparticle sample collection chamber 110. Connection means 320 may be a grooved connection means, a threaded connection means, an interlocking connection means, or some other suitable structure.

The filter bed 112 may additionally include a connection 332 for a vibration mechanism of a microparticle transport system 130 (e.g., vibration mechanism 131), which may include a shaker, an ultrasonic vibration source, or some other vibration source. For example, the connection 332 may be a threaded connection. Connection 336 may be a similar connection for a vibration mechanism. In the example shown here, connection 332 may be a male threaded connection while connection 336 may be a female threaded connection. Either connection type may provide a useful connection point, depending on the kind of connections available for the potential vibration mechanisms or other devices. Connections 332 and 336 may alternatively or additionally be used to mount the filter bed 112 (and by extension the microparticle sample collection chamber 110) to a frame or other structure which may be used to transport the device 100 to an on-site sampling location.

Additionally or alternatively, the filter bed 112 may include an angled connector 334. In implementations, the angled connector 334 may allow the filter bed 112 to be positioned at an angle, making the angle between the ground and the angled channel steeper (e.g., closer to vertical or 90 degrees from the plane of the ground. Thus the angled connector 334 may be configured to complement the angle of the angled second outlet 115. For example, if the angle of the second outlet 115 is approximately 26 degrees from the plane of the filter bed recess 312, the angle of the angled connector 334 may be between 44 and 64 degrees to provide a total combined angle relative to a horizontal plane of between 70 and 90 degrees. This combined angle should be constrained to prevent over rotation, which may decrease microparticle transport efficiency. For example, if the angle of the second outlet 115 is 45 degrees, the angle of the angled connector should not exceed 45 degrees or over rotation would occur. The angled connector 334 may be adjustable, or it may be fixed at the time the filter bed 112 is formed.

This angle change would also be applied to a corresponding microparticle filter 113 and the microparticle sample collection chamber 110, when assembled together with the filter bed 112. In some implementations, the angled connector 334 may be mounted to a fixed position. In other implementations, the angled connector 334 may be mounted to a rotating pivot (e.g., a motorized pivot, which may be an example of rotation mechanism 132) so the angle at which the filter bed 112 and the angled second outlet 115 is positioned can be changed. In some instances, a motorized pivot to which the angled connector 334 is mounted may include a motor that can adjust its position to different angles in a controlled manner (e.g., a stepper motor). In some implementations, the motorized pivot may have a locking mechanism or a ratcheting mechanism to prevent the angular position of the filter bed 112 from changing after a desired angular position is reached. One reason for an angled connector 334 or for rotating the filter bed 112 at the angled connector 334 is to increase the angle between the second outlet 115 and a horizontal plane, which may facilitate the migration of microparticles from the surface of the microparticle filter 113 to an output of the second outlet 115. For example, by rotating the filter bed 112, the second opening 315 may be made lower than most of the recess 312, and microparticles isolated at the surface of the microparticle filter may slide toward the lower point under the influence of gravity. A steeper overall combined angle of the second outlet 115, as when combined with an angle introduced by a motorized pivot, may facilitate microparticle transport more effectively than a shallow overall angle. For example, a combined overall angle of 70-85 degrees may facilitate faster microparticle transport from the microparticle filter 113 than a combined angle of only 30-60 degrees.

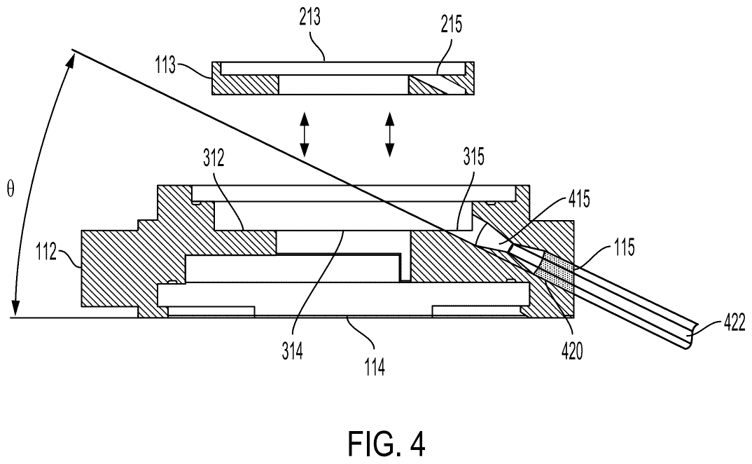

FIG. 4 shows an exploded cross-sectional view of an example filter bed for a microparticle sample collection chamber or a microparticle chemical treatment chamber according to embodiments of the present invention. Like in the perspective view discussed above, the filter bed 112 includes a recess 312, a first opening 314 in the recess 312 corresponding to a first outlet 114, a second opening 315 in the recess 312 corresponding to a second outlet 115. The space between the second opening 315 and the second outlet 115 may form an angled channel. The structural shape of the angled channel may facilitate the transfer of microparticles out of the second outlet 115. Generally, the angled channel should be formed with few or no internal corners or bends to prevent microparticles from getting lodged or trapped in the corners or bends. For example, angled channel could be formed with smooth walls. A round (e.g., circular or elliptical) cross-section of the angled channel may produce this effect, although other shapes may be used. Reducing the number of microparticles that are trapped in the angled channel increases the number of microparticles that are transferred to a successive stage through the angled channel.

In some implementations, the angled channel may be formed as a funnel 415. Funnel 415 may facilitate the concentration or flow of microparticles through the angled channel. For example, funnel 415 may be tapered, or funnel 415 may be substantially cone shaped. Additionally or alternatively, funnel 415 may facilitate the connection of a connector 420 to the angled channel of the second outlet 115. Alternatively, the angled channel may be formed with no funnel 415, such that the angled channel is relatively straight from the second opening 315 to the second output 115. Alternatively, the angled channel may be formed as a stepped channel (e.g., with the funnel 415 made with stepped sides), provided that the dimensions of steps in the stepped channel do not cause unacceptable particle trapping in corners of the steps. An outflow conduit 422 may be attached to the connector 420. Connector 420 may be a standard connector or a custom connector. A cone-shaped funnel 415 may match the shape and dimensions of a standard connector 420.

The angled channel, including the second opening 315 and second outlet 115, may be disposed in the filter bed 112 at an angle θ from a plane of the filter bed 112 (or from a plane of the recess 312 or a plane of the surface 213 of the microparticle filter 113, either of which may be substantially parallel to the plane of the filter bed 112). The angle θ may be configured to encourage migration of microparticles from the surface 213 of the microparticle filter 113 to the second outlet 115 and into the outflow conduit 422. In some implementations, the angle θ may be between 10 degrees and 45 degrees. In some implementations the angle θ may be between 20 and 30 degrees. In one example, the angle θ may be about 25 degrees or 26 degrees. The angle θ may be determined to complement the angle of the angled connector 334 discussed above, such that the combined angle of θ plus the angle of the angled connector 334 is less than or equal to 90 degrees.

Different combined angles may be desired for different factors in microparticle sample collection and transport. For example, numerous factors may influence a minimum or maximum angle between the angled channel and a horizontal reference that may be reached and achieve microparticle transport within reasonable parameters of time, flow rate, and amount of sample transported. Factors may include whether a rinsing fluid is applied to the microparticles, how many times a rinsing fluid is applied to the microparticles, the viscosity of the rinsing fluid, how readily microparticles become suspended in the rinsing fluid, the strength of electrostatic or chemical attractions between the microparticles and the first microparticle filter 113 or the filter bed, the strength of vibrations applied, if any, the length of time at which a vibration was applied, a frequency of the vibrations applied, the pore size of the microparticle filter 113 (also referred to as a thread diameter or a mesh size) relative to the size of particles intended to be captured, or a combination of some or all of the above. For example, when the ratio between the size of the microparticles and the pore size of the microparticle filter 113 is larger, more microparticles may be transferred. This may mean that fewer microparticles become lodged at the surface 213 of the microparticle filter 113, which increases the number of particles transferred.

Also shown in FIG. 4 is a cross-sectional view of a microparticle filter 113, including a surface 213 and an opening 215 in the microparticle filter. In the example shown, microparticle filter 113 may nest within the recess 312 of the filter bed 112. In some implementations, the opening 215 may be formed as a void that may be positioned over the second opening 315. In such a configuration, the filtered microparticles may migrate from the surface 213 and exit to the second opening 315 through the opening 215. Alternatively, the opening 215 may be formed in the microparticle filter 113 with a deformation that conforms to the detent of opening 315 and likewise allow filtered particulates to exit the microparticle filter 113. For example, the angle of the opening 215 may match the angle θ of the angled channel to the second outlet 115. As another alternative, rather than an opening 215, the microparticle filter 113 could be perforated or otherwise have sufficient material removed at the area over the second opening 315 to allow the particulates to exit the filter.

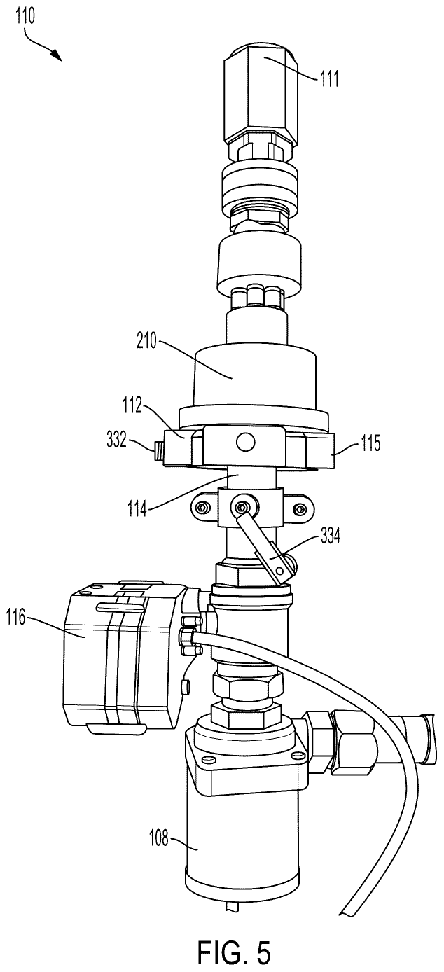

FIG. 5 shows a perspective view of an example configuration of a microparticle sample collection chamber 110 according to embodiments of the present invention. In the example of microparticle sample collection chamber 110 shown in FIG. 5, the several components discussed above with respect to some embodiments are shown as assembled together for operation, including a first inlet 111, a first enclosing member 210, a filter bed 112, a first outlet 114, a second outlet 115, a connection 332 for a vibration mechanism, an angled connector 334, a valve (e.g., a shutter valve) 116, and a fluid pump 108.

Returning to the depiction in FIG. 1, the device 100 may include a microparticle chemical treatment chamber 120. The microparticle chemical treatment chamber 120 may be connected to the second outlet 115 of the microparticle sample collection chamber 110 and configured to receive microparticles from the microparticle sample collection chamber 110. The microparticles isolated from the aqueous sample may be transported into the microparticle chemical treatment chamber 120 from the microparticle sample collection chamber 110 through a transfer mechanism 133, which may include a conduit and a pump (e.g., a peristaltic pump or other suitable pump structure). Embodiments including a peristaltic pump may help prevent contamination as the pumping motion of the pump is applied outside of the conduit, which means that the microparticles would not directly interact with the pumping mechanism of the transfer mechanism 133. The microparticles may be received at a second microparticle filter 123 disposed in a second filter bed 122. The second microparticle filter 123 may include a porous surface made of a chemically inert material so that it is not affected by chemical treatments applied to the microparticles. In some implementations, the entire second microparticle filter 123 may be made of a chemically inert material.

The microparticle chemical treatment chamber 120 may include inlets and outlets for various chemicals to be applied to the microparticles. For example, the microparticle chemical treatment chamber 120 may include inlets for one or more chemicals, shown in FIG. 1 as chemical sources 121a, 121b, and 121c. The chemical sources 121a, 121b, and 121c may include chemical pumps (e.g., peristaltic pumps). In the example of chemical sources 121a and 121b, the chemicals may be pumped directly into the chemical treatment chamber 120. In the example of chemical source 121c, the particular chemical may corrode or attack tubing used in peristaltic pumping. Suppose that the particular chemical supplied by the chemical source 121c is acetone. Acetone reacts with and damages silicone tubing, which is commonly used in peristaltic pumps. Pumping acetone directly into silicone tubing to be peristaltically pumped into the chamber could cause damage or failure of the tubing or pump, and potentially sample contamination. To overcome this problem, a pump may increase air pressure in a container of the chemical source 121c of acetone, thereby forcing out the acetone through a tube material that does not react strongly with acetone, such as PTFE, aluminum, fiberglass, or stainless steel. Peristaltic pumps may be used as air pumps for such applications, or other suitable air pumps could be used. Using an air pump to increase air pressure in the container of a chemical may cause the acetone to be introduced into the microparticle chemical treatment chamber without directly pumping the acetone itself. It should be noted that while using an air pump is described with the example of introducing acetone to the chamber, such air pumping could be applied to other chemical sources (e.g. chemical sources 121a or 121b), whether or not the chemicals from the other chemical sources would react with pump tubing (e.g., peristaltic pump tubing).

To facilitate chemical treatment, the microparticle chemical treatment chamber 120 may include a chemical waste container 124. The chemical waste container 124 may be configured with a connection to a vacuum pump 125, which may facilitate effective transfer of chemicals onto the microparticles received at the second microparticle filter 123. The chemical treatments applied to the microparticles may include applying a dye to the microparticles; applying ethanol, isopropyl alcohol, or another alcohol to the microparticles; applying acetone or another solvent to the microparticles; applying water (e.g., distilled water or deionized water) to the microparticles; applying an alkali or an acid to the microparticles; removing, dissolving, or otherwise changing particles not of interest (e.g., organic particles, or particles which are not microplastics), applying heat to the microparticles, applying an abrasive material to the microparticles, applying a binding agent to the microparticles, applying a rinsing fluid or a carrying fluid, or a combination thereof. For example, a Fenton reaction may be caused in the microparticle chemical treatment chamber 120 to digest organic matter without significantly affecting microplastic particles.

The microparticle chemical treatment chamber 120 may include a heating element 126. The heating element 126 may be an electrically powered heater. In some embodiments, the heating element 126 may include a ceramic heating element. Additionally or alternatively, the heating element 126 may include resistive wire. The heating element 126 may be configured as a coil around or within the microparticle chemical treatment chamber 120. The heating element 126 may be made small enough to nest within the microparticle chemical treatment chamber 120, and thereby facilitate a compact and portable implementation. In addition to being made compact, a coiled structure of the heating element may enable even heat distribution to the sample of microparticles. Use of a heating element 126 may increase the efficiency or reduce the reaction time of some chemical reactions, thus reducing the time needed for chemical treatment. In some embodiments, the microparticle chemical treatment chamber 120 may be made of aluminum to facilitate fast distribution of heat from the heating element 126 the microparticles, although other heat conductive materials may be used.

The heating element 126 may be configured to operate from the same power supply as the first pump 102 or the second pump 108. For example, the heating element 126 may be made operable when connected to a 12 V or 24 V power supply. In some implementations, the optional controller 140 may be configured to provide power to the heating element 126 as needed. For example, a temperature sensor (not shown) may be included to provide feedback so that a control system of the controller 140 may apply power to the heating element 126 to keep the temperature within the microparticle chemical treatment chamber 120 at a specified temperature. The specified temperature may be a temperature useful in facilitating a chemical reaction within the microparticle chemical treatment chamber 120. In some implementations, the heating element 126 may be powered only when part of a corresponding chemical treatment of the microparticles.

Application of a chemical treatment to the microparticles may be performed in an automated manner, or without manual application or transfer of the microparticles. For example, the microparticle chemical treatment chamber 120 may include temperature sensors or liquid level sensors (not shown). The temperature sensors and/or liquid level sensors may provide triggering signals to the controller 140 that may cause the controller 140 to pump chemicals into the chamber or stop pumping chemicals into the chamber as the case may be, to apply heat to the chamber with the heating element 126, to change the air pressure in one or more portions of the microparticle chemical treatment chamber 120, and so on. A benefit of such automated chemical treatment is that the chemical treatment process can be applied entirely internally to the microparticle chemical treatment chamber 120, which may help prevent chemical contamination of the microparticle sample. Another benefit to performing a chemical treatment process entirely within the microparticle chemical treatment chamber 120 is that so doing may protect people, equipment, the environment, or other things from exposure to the microparticle samples and/or chemicals applied during the chemical treatment. Removing human handling of chemicals from a chemical process removes much of the risk of injury to a human from handling the chemicals.

When the chemical treatment is complete, the microparticles may be transferred out of the microparticle chemical treatment chamber 120 at outlet 127. Outlet 127 may be an angled outlet similar to the second outlet 115 of the microparticle sample collection chamber 110 discussed above. The microparticle chemical treatment chamber 120 may include one or more components or mechanisms configured to encourage migration of the microparticles to the output of the outlet 127 in combination with the angle of the outlet 127. For example, microparticle chemical treatment chamber 120 of examples may include a reservoir, a rinsing fluid supply, a rinsing fluid pump, one or more nozzles connected at a rinsing fluid inlet of the microparticle chemical treatment chamber 120, or a combination thereof configured to encourage migration of microparticles. For example, at least one or more of the chemical supplies 121a, 121b, and 121c and their respective chemical pumps 128a, 128b, and 128c may be configured to apply a rinsing fluid to the microparticles after other chemical treatment has been performed on the microparticles. Using the rinsing fluid, microparticles may be flushed or encouraged to migrate from the second microparticle filter 123 in a similar manner to that as has been disclosed above with respect to microparticle sample collection chamber 110. Increased or decreased air pressure in the microparticle chemical treatment chamber 120, such as from vacuum pump 125 or a separate air pump (not shown) may also be used to facilitate migration of microparticles from the microparticle chemical treatment chamber 120.

The microparticle chemical treatment chamber 120 of examples may also be connected to one or more components or mechanisms of the microparticle outflow transport system 130 shown in FIG. 1, such as vibration mechanism 134, rotation mechanism 135, and transfer mechanism 136, which may facilitate the migration of the microparticles from the microparticle chemical treatment chamber 120. The components, mechanisms, and devices of the microparticle outflow transport system 130 may be configured to work in combination with the geometry of the microparticle chemical treatment chamber 120 and its respective chemical processes. For example, the combined application of mechanisms within the chamber and outside the chamber may create a more effective transport of microparticles than may be achieved by any one of the mechanisms applied alone.

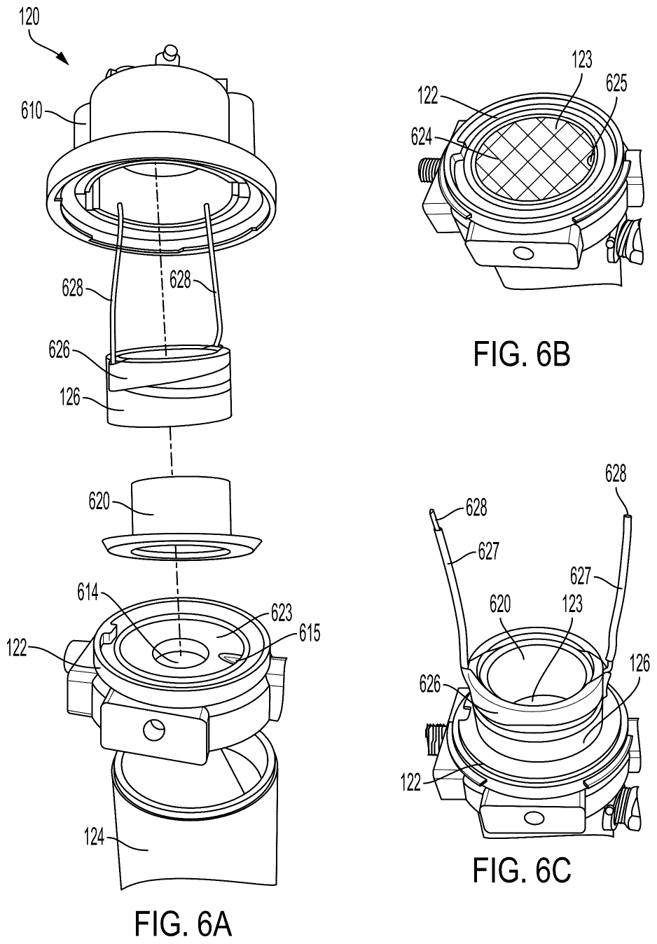

Reference is now made to FIG. 6A, which shows an exploded view of an example configuration of a microparticle chemical treatment chamber 120 according to embodiments of the present invention. The microparticle chemical treatment chamber 120 may include a similar structure to the microparticle sample collection chamber 110 discussed above, such as with reference to FIGS. 2 and 3, and may function similarly. For example, the microparticle chemical treatment chamber 120 may include an enclosing member 610, a heating element 126, a reservoir 620, a filter bed 122, a microparticle filter 123, a first outlet 614, a second outlet 615, and a chemical waste container 124.

The heating element 126, the filter bed 122, the second microparticle filter 123, the reservoir 620, and/or other components of the microparticle chemical treatment chamber 120 may be configured to nest within one another and within the enclosing member 610 of the microparticle chemical treatment chamber 120. An advantage of such a configuration is that it creates a more compact and thus more portable chamber, useful for field applications.

The filter bed 122 may include a recess 623 in which the microparticle filter 123 may be disposed. The first outlet 614 and the second outlet 615 may be disposed in the filter bed 122 in a similar manner to outlets discussed above. In an embodiment, the recess 623 may be made of PTFE or another suitable material that it is chemically inert to the chemical treatment processes.

Reference is made to FIG. 6B, which illustrates a perspective view of a of an example configuration of a microparticle chemical treatment chamber 120 according to embodiments of the present invention. The microparticle filter 123 may be made of PTFE, and a surface 624 of the microparticle filter 123 may include pores of 0.1 μm. According to embodiments, the microparticle filter 123 may include an opening 625 corresponding to the second outlet 615. The functionality of the filter bed 122, microparticle filter 123, and other components of the microparticle chemical treatment chamber 120 may be configured in a similar manner to the microparticle sample collection chamber 110 discussed above. For example, the second outlet 615 may be configured at an angle in a similar manner to the second outlet 115 discussed above.

In some implementations, the microparticle chemical treatment chamber may include a chemical waste container 124. The chemical waste container 124 may be made of a suitable material, such as metal, glass, fiberglass, or PTFE. In some implementations, positive or negative air pressure may be applied to the microparticles on the second microparticle filter and/or to one or more components of the microparticle chemical treatment chamber, such as the chemical waste container. Application of positive or negative air pressure may facilitate application of a chemical treatment to the microparticles. For example, applying air pressure may encourage rapid transfer of chemicals to the microparticles or to the chemical waste container.

Reference is made to FIG. 6C, which illustrates a perspective view of a of an example configuration of a microparticle chemical treatment chamber 120 according to embodiments of the present invention. In the view of FIG. 6C, an example configuration of how heating element 126 may be configured to nest around the reservoir 620, over the second microparticle filter 123, and in or on the second filter bed 122. For example, the heating element may snugly fit around the reservoir 620. In this example configuration, heat transfer may be made more effectively if the heating element 126 is in close contact with the reservoir.

To prevent electrical shorting, an insulating barrier 626 may be applied to the heating element 126. A similarly insulating barrier 627 may be applied to electrical leads 628. The insulating barriers 626 and 628 may be made of any suitable insulating material. For example, the insulating barrier 626 may be made of PTFE tape, a silicone or plastic coating, or another suitable insulator, and the insulating barrier 627 may be made of the same or similar materials. In addition to protecting against electrical shorting, the insulating barriers 626 and 627 may also protect components of the system against unwanted heat transfer, or from potential chemical reactions with chemicals introduced in the chemical treatment chamber 120.

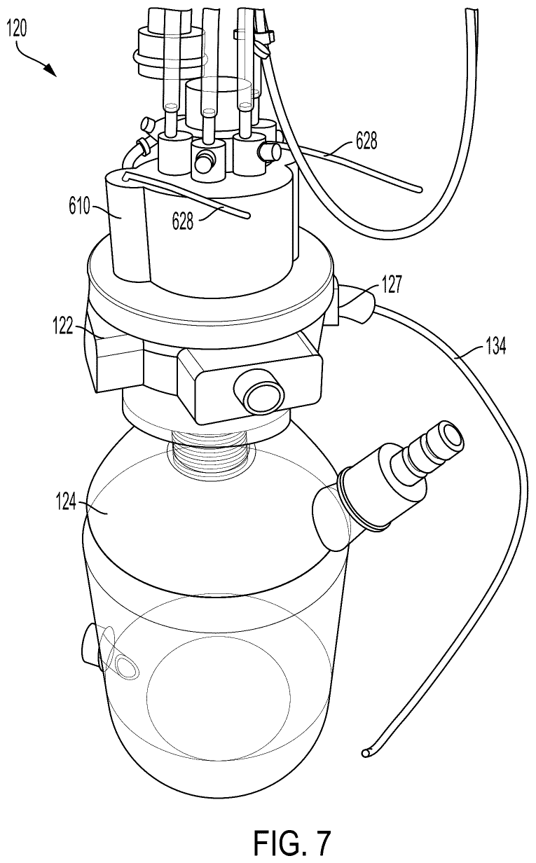

FIG. 7 shows a perspective view of an example configuration of a microparticle chemical treatment chamber according to embodiments of the present invention. The view of FIG. 7 provides an example of what the microparticle chemical treatment chamber 120 may look like when assembled. The microparticle chemical treatment chamber 120 may include functionality to transport microparticles from the microparticle chemical treatment chamber 120 after a chemical treatment is applied to the microparticles, including components of a microparticle outflow transport system 130, such as an outflow transport tube 136.

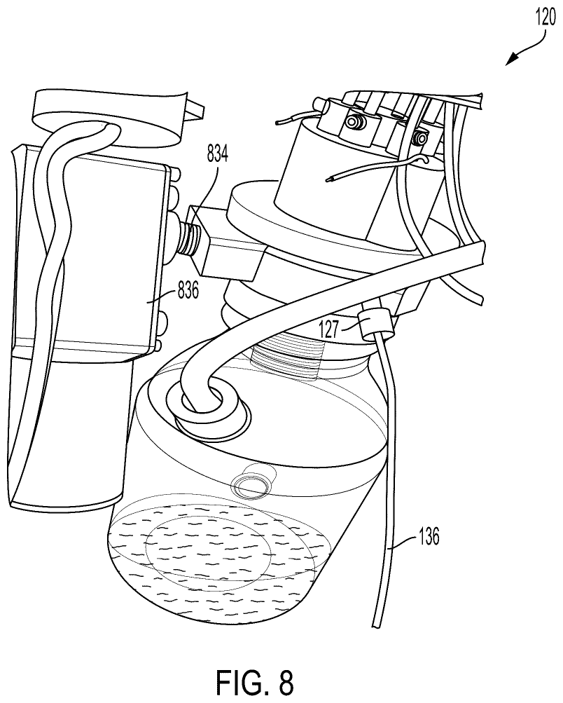

FIG. 8 shows a perspective view of an example microparticle outflow transport system according to embodiments. Exemplary components of the systems have been discussed above with respect to the components of the microparticle outflow transport system 130 connected to the microparticle sample collection chamber 110 (e.g., vibration mechanism 131, transfer mechanism 133 including its pump, or the rinsing fluids supply 118, or rinsing fluid pump(s) 119 discussed above). Similar transfer mechanisms are enabled within and at the outlets of the microparticle chemical treatment chamber 120, including outflow transport tube 136, vibration mechanism 133, and one or more of the chemical supplies 121a-121c.

In the example of FIG. 8, the microparticle chemical treatment chamber 120 is shown as mounted via an angled connector 834 to a motorized pivot 836 such that the microparticle chemical treatment chamber 120 is angled with second outlet 127 lower relative to other portions of the chamber. Motorized pivot 836 may be an example of a rotation mechanism 135, such as has been described herein. A similar motorized pivot may be provided for rotation mechanism 132. The angled connector 834 may be similar to the angled connector 334 disclosed above. The angle may facilitate migration of chemically treated microparticles out of the outflow transport tube 136. The outflow transport tube 136 may be connected to other outflow transport components (not shown), such as a vibration mechanism, additional pumps, chemical analysis or microparticle detection apparatuses, microparticle collection containers, and so on.

Referring back to FIG. 1, microparticle outflow transport system 130 may include mechanisms designed to encourage or facilitate the transport of microparticles from either or both of the microparticle sample collection chamber 110 and the microparticle chemical treatment chamber 120. The microparticle outflow transport system(s) may include a rotation mechanism (e.g., a motor) configured to rotate the chamber and bring the angled outlet of the respective microparticle filter to a steeper angle, thereby facilitating the migration of the microparticles from the chamber. The microparticle outflow transport system(s) may include a vibration mechanism (e.g., an ultrasonic vibration mechanism) to facilitate migration of the microparticles from the chamber. The microparticle outflow transport system(s) may include one or more pumps connected to the outlets of the chamber configured to facilitate migration of the microparticles from the chamber. Optionally, the microparticle outflow transport system(s) may include a centrifuge mechanism whereby the chamber is spun to encourage microparticle outflow from the chamber.

The microparticle outflow transport system(s) 130 may operate in combination with components inside the respective chambers, including the angled geometry of the outlets from the chambers, and chemical rinse processes (e.g., the introduction of a chemical in which the microparticles may be suspended), to facilitate migration of the microparticles from the chamber. For example, the combined application of components, mechanisms and geometries within the chamber and components and mechanisms outside the chamber may create a more effective transport of microparticles than may be achieved by any one of the mechanisms applied alone. For portable systems, this may be advantageous because it means that the throughput for microparticle collection, treatment, and subsequent analysis can be made higher, increasing the usefulness of the system in providing timely results. More effective combinations of mechanisms may also have the benefit of being more energy efficient.

In FIG. 1, Controller 140 of device 100 provides operation for controlling various aspects of the device 100, including controlling the several fluid pumps, chemical pumps, air pressure pumps, valves, chemical applicators, heating elements, vacuum pumps. For example, controller 140 may comprise one or more processors operable to execute logic implementing various functions for microparticle sample collecting and chemical treatment of the same. Controller 140 may, for example, comprise one or more general purpose processors (e.g., a processor from the CORE family of processors available from Intel, Inc., a processor from the BCM28XX family of system-on-chip (SoC) processors available from Broadcom Inc., a field programmable gate array (FPGA), etc.), one or more special purpose processors (e.g., an application specific integrated circuit (ASIC), a hardware logic array, etc.), or combinations thereof.

Microparticle sample collection and chemical treatment operations may be implemented in logic stored in a memory of the controller 140 illustrated in FIG. 1. Controller 140 may, for example, provide code segments (e.g., one or more instruction set in the form of software and/or firmware code segments) for performing operations as have been described herein. Controller 140 may be further configured to receive inputs from one or more sensors incorporated into the several chambers and conduits of the device 100 and implement instructions to components of the device 100 to adjust microparticle sample collection and chemical treatment processes or subprocesses.

When implemented in software and/or firmware, the functions of logic providing aspects of microparticle sampling and chemical treatment techniques of embodiments of the present invention may comprise code segments to perform tasks as described herein. The code segments can be stored in a processor readable medium of a memory for execution by the controller 140. The processor readable medium may include any medium that can suitably store and transfer information. Examples of the processor readable medium of memory include a semiconductor memory device, a read only memory (ROM), a flash memory, an erasable ROM (EROM), an optical disk, a hard disk, etc.

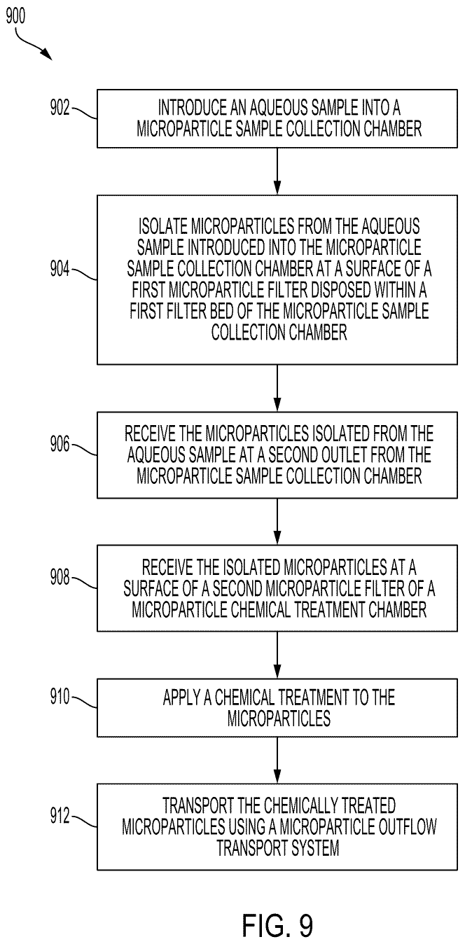

FIG. 9 shows a flowchart of an example process for performing microparticle sample collection and chemical treatment according to embodiments of the present invention. For example, FIG. 9 shows flow 900 illustrating functions of a device 100 for sampling a fluid sample (e.g., an aqueous solution) from a source, isolating microparticles from the fluid sample, chemically treating the microparticles, and transporting the chemically treated microparticles from the device 100. To aid in understanding the concepts of the present invention, the example of flow 900 is described with reference to particular implementations as have been described herein. It should be appreciated, however, that other processes and flows may be utilized according to embodiments of the invention.

At block 902 of the illustrated embodiment of flow diagram 900, an aqueous sample is introduced into a microparticle sample collection chamber. Introducing the aqueous sample may include pumping the sample into the microparticle sample collection chamber. For example, pumping the sample into the microparticle sample collection chamber may include pumping the aqueous sample through one or more microparticle filters configured to remove microparticles from the aqueous sample solution. In some implementations, introducing the aqueous sample may include pushing the aqueous components of the aqueous sample through the first microparticle filter by a first pump configured at an inlet of the microparticle sample collection chamber, and pulling the aqueous components through the first microparticle filter by a second pump connected to a first outlet of the microparticle sample collection chamber.

At block 904 of the illustrated embodiment of flow diagram 900, microparticles from the aqueous sample may be isolated at a surface of a first microparticle filter disposed within a first filter bed of the microparticle sample collection chamber. This may be accomplished by moving the aqueous sample solution through the microparticle filter.

At block 906, the microparticles isolated from the aqueous sample are received at a second outlet from the microparticle sample collection chamber. The second outlet may be disposed in the first filter bed at an angle to a plane of the surface of the first microparticle filter configured to encourage migration of the microparticles from the surface of the first microparticle filter to an output of the second outlet. For example, the angle of the second outlet may be between substantially parallel to the plane of the surface of the first microparticle filter and substantially perpendicular to the plane of the surface of the first microparticle filter.

To facilitate migration of the microparticles, a volume of a fluid may be applied at the surface of the first microparticle filter to facilitate migration of the microparticles from the microparticle sample collection chamber to the microparticle chemical treatment chamber. Additionally or alternatively, facilitating migration of the microparticles may include rotating the microparticle sample collection chamber from a first angular position to a second angular position. For example, a first angular position of the plane of the surface of the first microparticle filter may be substantially parallel to a horizontal plane, and a second angular position may be offset from parallel to the horizontal plane to facilitate migration of the microparticles from the microparticle sample collection chamber to the microparticle chemical treatment chamber. Additionally, or alternatively, the process may include applying a vibration to the microparticle sample collection chamber to facilitate migration of the microparticles from the microparticle sample collection chamber to the microparticle chemical treatment chamber.

At block 908, the isolated microparticles may be received at a surface of a second microparticle filter of a microparticle chemical treatment chamber. At block 910, a chemical treatment may be applied to the microparticles. For example, a chemical treatment may be applied in accordance with methods and techniques described herein.

At block 912, the chemically treated microparticles may be transported using a microparticle outflow transport system. For example, between the introducing of the aqueous sample into the microparticle sample collection chamber and the transporting of the microparticles, the microparticles may be maintained in an enclosed sample processing environment isolated from an external environment, the enclosed sample processing environment being configured to transport the microparticles between the microparticle sample collection chamber and the microparticle sample collection chamber without removal of the microparticles from the enclosed sample processing environment.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A device for microparticle sample collection and chemical treatment, the device comprising:
a microparticle sample collection chamber including:
a first filter bed enclosed in the microparticle sample collection chamber;
a first microparticle filter disposed within the first filter bed and configured to isolate microparticles from an aqueous sample introduced into the microparticle sample collection chamber, wherein the microparticles are isolated at a surface of the first microparticle filter;
a first outlet from the microparticle sample collection chamber configured to drain aqueous components of the aqueous sample from the microparticle sample collection chamber after the microparticles have been isolated from the aqueous sample; and
a second outlet from the microparticle sample collection chamber
disposed in the first filter bed to receive the microparticles isolated from the aqueous sample and
configured at an angle to a plane of the surface of the first microparticle filter to encourage migration of the microparticles from the surface of the first microparticle filter to an output of the second outlet, the angle of the second outlet being between 10 and 45 degrees from the plane of the surface of the first microparticle filter;
a microparticle chemical treatment chamber including:
a second filter bed enclosed in the microparticle chemical treatment chamber;
a second microparticle filter disposed within the second filter bed configured to receive the microparticles at a surface of the second microparticle filter for a chemical treatment of the microparticles; and
a third outlet from the microparticle chemical treatment chamber
disposed in the second filter bed to receive the microparticles after the chemical treatment of the microparticles and
configured at an angle to a plane of the surface of the second microparticle filter to encourage migration of the microparticles from the surface of the second microparticle filter to an output of the third outlet, the angle of the third outlet being between 10 and 45 degrees from the plane of the second microparticle filter,
wherein the microparticle sampling collection chamber and the microparticle chemical treatment chamber provide an enclosed sample processing environment isolated from an external environment; and
a microparticle outflow transport system configured to transport the microparticles from either or both of the microparticle sample collection system and the microparticle chemical treatment chamber without removal of the microparticles from the device.

2. The device of claim 1, further comprising:
a first pump configured to introduce the aqueous sample into the microparticle sample collection chamber by pushing the aqueous components of the aqueous sample through the first microparticle filter; and
a second pump connected to the first outlet of the microparticle sample collection chamber and configured to facilitate draining the aqueous components of the aqueous sample from the microparticle sample collection chamber by pulling the aqueous components through the first microparticle filter.

3. The device of claim 2, wherein the first pump and the second pump are selectively configurable to pump the aqueous components of the aqueous sample through the first microparticle filter in a forward direction or in a reverse direction.

4. The device of claim 1, further comprising a valve disposed at the first outlet from the microparticle sample collection chamber and configured to close the first outlet to facilitate migration of the microparticles from the surface of the first microparticle filter to the second outlet from the microparticle sample collection chamber.

5. The device of claim 1, wherein the first microparticle filter includes an opening configured to facilitate the migration of the isolated microparticles to the second outlet from the microparticle sample collection chamber.

6. The device of claim 1, wherein the microparticle sample collection chamber further comprises a reservoir configured to receive a volume of a fluid at the surface of the first microparticle filter to facilitate the migration of the filtered microparticles to the second outlet from the microparticle sample collection chamber.

7. The device of claim 6, wherein the first filter bed, the first microparticle filter, and the reservoir are configured to nest together within a first enclosing member to form the microparticle sample collection chamber in a compact form.

8. The device of claim 1, wherein the microparticle chemical treatment chamber further comprises:
a connection to a chemical supply configured to deliver a chemical treatment to the microparticles; and
a chemical waste container configured to receive waste products of the chemical treatment.

9. The device of claim 8, wherein the chemical waste container is connected with a vacuum pump or an air pressure pump configured to apply a positive or negative air pressure to the microparticle chemical treatment chamber to facilitate the chemical treatment.

10. The device of claim 8, wherein the connection to the chemical supply includes an air pump configured to increase air pressure in a container of a chemical, to cause the chemical to be introduced into the microparticle chemical treatment chamber without directly pumping the chemical.

11. The device of claim 1, wherein the second microparticle filter in the microparticle chemical treatment chamber includes an opening configured to facilitate the migration of the microparticles to the third outlet from the microparticle chemical treatment chamber after the microparticles have received a chemical treatment.

12. The device of claim 1, wherein the microparticle chemical treatment chamber further comprises a heating element configured to provide heat to the microparticles when the microparticles are at the surface of the second microparticle filter as part of the chemical treatment of the microparticles.

13. The device of claim 1, wherein the chemical treatment includes applying a dye to the microparticles or causing a Fenton reaction within the microparticle chemical treatment chamber.

14. The device of claim 1, wherein the microparticle outflow transport system comprises a motorized pivot coupled to one of the microparticle sample collection chamber and the microparticle chemical treatment chamber and configured to rotate the respective chamber to an angle to facilitate the migration of the microparticles from the respective chamber, wherein the angle of rotation is configured such that an angle between an outlet of the chamber and a horizontal plane is between 75 and 90 degrees.

15. The device of claim 1, wherein the microparticle outflow transport system comprises a vibration device coupled to the microparticle chemical treatment chamber and configured to facilitate the migration of the microparticles from the surface of the second microparticle filter to the output of the third outlet from the microparticle chemical treatment chamber.

16. A method for microparticle sample collection and chemical treatment, the method comprising:
introducing an aqueous sample into a microparticle sample collection chamber;
isolating microparticles from the aqueous sample introduced into the microparticle sample collection chamber at a surface of a first microparticle filter disposed within a first filter bed of the microparticle sample collection chamber;
receiving the microparticles isolated from the aqueous sample at a second outlet from the microparticle sample collection chamber, the second outlet disposed in the first filter bed at an angle to a plane of the surface of the first microparticle filter configured to encourage migration of the microparticles from the surface of the first microparticle filter to an output of the second outlet, the angle of the second outlet being between substantially parallel to the plane of the surface of the first microparticle filter and substantially perpendicular to the plane of the surface of the first microparticle filter;
receiving the isolated microparticles at a surface of a second microparticle filter of a microparticle chemical treatment chamber;
applying a chemical treatment to the microparticles; and
transporting the chemically treated microparticles from either or both of the of the microparticle sample collection system and the microparticle chemical treatment chamber using a microparticle outflow transport system,
wherein between the introducing of the aqueous sample into the microparticle sample collection chamber and the transporting of the microparticles the microparticles are maintained in an enclosed sample processing environment isolated from an external environment, the enclosed sample processing environment being configured to transport the microparticles between the microparticle sample collection chamber and the microparticle sample collection chamber without removal of the microparticles from the enclosed sample processing environment.

17. The method of claim 16, further comprising:
pushing the aqueous components of the aqueous sample through the first microparticle filter by a first pump configured at an inlet of the microparticle sample collection chamber; and
pulling the aqueous components through the first microparticle filter by a second pump connected to a first outlet of the microparticle sample collection chamber.

18. The method of claim 16, further comprising:
applying a volume of a fluid at the surface of the first microparticle filter to facilitate migration of the microparticles from the microparticle sample collection chamber to the microparticle chemical treatment chamber.

19. The method of claim 16, further comprising:
rotating the microparticle sample collection chamber from a first angular position, at which the plane of the surface of the first microparticle filter is substantially parallel to a horizontal plane, to a second angular position offset from parallel to the horizontal plane to facilitate migration of the microparticles from the microparticle sample collection chamber to the microparticle chemical treatment chamber.

20. A device for microparticle sample collection and chemical treatment, the device comprising:
a first pump configured to introduce an aqueous sample into a microparticle sample collection chamber,
a second pump configured to pull the aqueous sample out of the microparticle sample collection chamber,
the microparticle sample collection chamber, including:
a first filter bed enclosed in the microparticle sample collection chamber;
a first microparticle filter disposed within the first filter bed and configured to isolate microparticles from the aqueous sample, wherein the microparticles are isolated at a surface of the first microparticle filter;
a first outlet from the microparticle sample collection chamber configured to drain aqueous components of the aqueous sample from the microparticle sample collection chamber after the microparticles have been isolated from the aqueous sample; and
a second outlet from the microparticle sample collection chamber disposed in the first filter bed to receive the microparticles isolated from the aqueous sample and configured at an angle to a plane of the surface of the first microparticle filter to encourage migration of the microparticles from the surface of the first microparticle filter to an output of the second outlet, the angle of the second outlet being between 10 and 45 degrees from the plane of the surface of the first microparticle filter;
a first transport fluid pump configured to introduce a fluid into the microparticle sample collection chamber to facilitate the migration of the microparticles from the surface of the first microparticle filter to the output of the second outlet, wherein the microparticles are suspended in the fluid;
a second fluid transport pump in fluid communication with the output of the second outlet configured to transport the microparticles suspended in the fluid into a microparticle chemical treatment chamber;
the microparticle chemical treatment chamber, including:
a second filter bed enclosed in the microparticle chemical treatment chamber;
a second microparticle filter disposed within the second filter bed configured to receive the microparticles at a surface of the second microparticle filter for a chemical treatment of the microparticles; and
a third outlet from the microparticle chemical treatment chamber
disposed in the second filter bed to receive the microparticles after the chemical treatment of the microparticles and configured at an angle to a plane of the surface of the second microparticle filter to encourage migration of the microparticles from the surface of the second microparticle filter to an output of the third outlet, the angle of the third outlet being between 10 and 45 degrees from the plane of the second microparticle filter,
wherein the microparticle sampling collection chamber and the microparticle chemical treatment chamber provide an enclosed sample processing environment isolated from an external environment and configured to transport the microparticles from the microparticle sampling collection chamber to the microparticle chemical treatment chamber without removal of the microparticles from the device; and
a microparticle outflow transport system configured to transport the microparticles from the third outlet from the microparticle chemical treatment chamber without removal of the microparticles from the device.
